(19) United States
(12) Patent Application Publication
(10) Pub. No.: US 2003/0195736 A1
(43) Pub. Date: Oct. 16, 2003

(54) Method of storing cross-hierarchy coupling data in a hierarchical circuit model

(75) Inventors: Pradiptya Ghosh, San Jose, CA (US); Robert J. Walsh, Sunnyvale, CA (US); Tuan V. Doan, San Jose, CA (US); Jean Hassoun, San Jose, CA (US)

Correspondence Address: SCOTT W HEWETT, 400 WEST THIRD STREET, #223, SANTA ROSA, CA, 95401

(73) Assignee: Sun Microsystems, Inc., Palo Alto, CA

(21) Appl. No.: 10/122,101

(22) Filed: Apr. 11, 2002

(51) Int. Cl. G06F 17/50

(52) U.S. Cl. 703/14

(57) ABSTRACT

Data clusters are added between functional blocks in a higher-level hierarchical circuit model. The data clusters account for inter-level parasitic values without flattening the circuit model to a lower hierarchical level and operate as an information graph or network between nodes, which can be used with the standard, or default, information graph between nodes. The data clusters also allow the use of standard functional blocks without introducing artificial nodes into the circuit at a lower level that could create a coupling point at a higher level. The use of data clusters allows rapid and accurate modeling of the circuit without flattening the circuit to the lowest level.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### BACKGROUND OF THE INVENTION

The invention relates generally to electronic circuit modeling or design using computer simulation, and more particularly to circuit modeling or design using a hierarchical approach.

Computer-aided design (“CAD”) has become an important tool in the development of new electronic circuits and devices. Generally speaking, circuit components, such as resistors, capacitors, and transistors, are modeled according to their expected behavior in a circuit. A computer program, typically called an extractor extracts data from silicon equivalent layout data and represents them as R, C, I connections. A computer program typically called a circuit simulator generates an output according to the circuit model's response to an input. For example, one terminal of a resistor might be connected to a node with one end of a capacitor, and the other end of the resistor and capacitor both connected to another node. The circuit simulator could then model the frequency response of the simple parallel RC network across the two nodes. A variety of electronic devices can be modeled, including electrical analog devices, digital devices, mixed hardware, electro-optical devices, and electro-mechanical devices, for example.

However, transistors and other devices can be much more complex to model than the relatively simple resistor or capacitor. A transistor can be modeled with a number of components, such as current sources, capacitors, inductors, and resistors, and the values for these components can be provided to a computer simulation program for evaluating a circuit with the modeled transistor.

Different types of transistors in a circuit can be modeled by changing the components and values of the elements associated with that device. This allows a designer to adjust various component values of the modeled device to evaluate how the operation of the device is affected by those changes. A higher level of the circuit model typically evaluates or models the circuit by treating the transistor as a component. This level of hierarchy simplifies the circuit model because there are fewer nodes and fewer circuit components to account for. The next level of hierarchy might combine several transistors into a functional block, such as a NAND gate, and so on to even higher hierarchical levels.

Generally, a higher-level model includes all the sub levels. It would be nice if a higher level could use standard components from the lower levels, but typically many of the lower level components have to be adjusted. For example, even if two transistors will be fabricated using essentially the same mask dimensions on the same wafer, the physical location of the transistors on the chip and their relation to other circuit components might cause one transistor to operate differently from the other. This difference can be compensated for by adjusting the values of the circuit components that model the transistors.

For example, if one transistor receives an input from a relatively long, thin metal trace, the input resistance and input inductance might be increased to reflect this condition, even though the transistor is nominally the same as another transistor modeled with lower input inductance. In another instance, a small capacitor might be added between a node of the modeled transistor and another circuit node because the metal trace associated with the node of the transistor is close to a metal trace associated with the second circuit node and the two traces will capacitively couple. These types of components that are added to model are commonly referred to as “parasitics”. In some instances, the parasitic values can be entered between existing nodes of the circuit. In others, an artificial, i.e. non-structural, node might need to be added to properly model the parasitic values. The artificial node basically creates a coupling point at a higher level of hierarchy.

The ability to adjust device parameters on a lower hierarchical level has become especially important as the speed of circuit operation increases and as device sizes decrease. As the devices become smaller and smaller, parasitic values can become greater portions of the component values. At higher frequencies, including digital operating (“clock”) speeds, the reactance and reluctance of the circuit, including parasitic values, become more important to accurately model so that a physical device (i.e. electronic circuit) can be designed without having to make and test successive versions of the circuit. The photolithography mask sets used in making an electronic circuit generally expensive to produce. Similarly, the time involved in re-designing a mask set and fabricating another run of wafers so that the resulting electronic devices can be tested is also relatively long. Therefore it is generally desirable to be able to electronically model the circuit to improve the performance of the resulting physical electronic device.

Even the time required to simulate a “flattened” complex electronic circuit can be quite long. The file size of a microprocessor, for example, might exceed a gigabyte when flattened to the “all transistor flat” level. Working with such a large file can cause the computer system being used to model the circuit to fail. Sometimes the circuit model can be partitioned, but this can introduce additional problems. Even if the computer system can model the flattened circuit, simulation might take a relatively long time, such as several hours or even overnight. This can slow the optimization process and delay the production of the electronic device.

Yet another issue arises from cross-hierarchy coupling. Cross-hierarchy coupling can arise in the physical electronic device from metal traces in one level of metallization crossing over a lower level of metallization, for example, the lower level might include several functional blocks with various logic gates and the upper level metallization might have a bus bar that overlies a portion of one functional block, creating an inter-level capacitance, but not another. One conventional approach to address this issue is to add a capacitor to the lower-level circuit, including an artificial node, if necessary. However, this change is propagated to all uses of this lower level circuit, which is not accurate or desirable. Another approach is to propagate the coupling element to an upper level of hierarchy, but then when the simulator goes into a lower level design hierarchy, this coupling is missing.

### BRIEF SUMMARY OF THE INVENTION

A cluster with inter-level coupling data is overlapped with a base cluster of an object at a level of hierarchy. The inter-level coupling data represents coupling between the level of hierarchy of the cluster and a higher level of hierarchy. Using cluster graphs with inter-level coupling data allows fast, accurate modeling of the circuit without having to “flatten” the data model or change the base view or base cluster of the object. Hence, the cross-hierarchy coupling information is pushed down into the lower hierarchy without the overhead of complete flattening of the circuit. The data in the cluster graph is easily changed to test proposed changes to the circuit that will affect inter-level coupling. The cluster graph can contain a virtual (non-structural or “artificial”) node to the higher hierarchy that is not propagated, yet accounts for the inter-level coupling at either level of hierarchy.

### BRIEF DESCRIPTION OF THE DRAWINGS

FIG. 1 is a simplified diagram illustrating a hierarchical data structure.

FIG. 2A is a simplified circuit diagram of a block at one level of hierarchy with gates at a lower level of hierarchy.

FIG. 2B is a simplified diagram representing the gate shown in FIG. 2A.

FIG. 2C is a simplified circuit diagram of a design block shown in FIG. 2A with a bus running across some elements of the design block.

FIG. 3A is a simplified diagram representing the top-level hierarchy of an RS latch illustrating an embodiment of the present invention in conjunction with FIGS. 3B-3D.

FIG. 3B is a simplified diagram of a NOR gate of the RS latch shown in FIG. 3A.

FIG. 3C is a simplified representation of a view of the NOR gate shown in FIG. 3B.

FIG. 3D is a simplified representation of a cluster base of the NOR gate shown in FIG. 3B.

FIG. 3E is a simplified representation of a cluster graph according to an embodiment of the present invention.

FIG. 4A is a simplified flow diagram of a method for creating a cluster graph according to an embodiment of the present invention.

FIG. 4B is a simplified flow diagram of a method of modeling an integrated circuit according to an embodiment of the present invention.

FIG. 4C is a simplified flow diagram of a method for creating a data model of an integrated electronic circuit according to an embodiment of the present invention.

### DETAILED DESCRIPTION OF THE INVENTION

Cluster graphs containing inter-leveling coupling data are overlayed with bases cluster in a hierarchical model of an electronic circuit on a CAD tool. This relieves the circuit designer from modifying a standard object in the library or having to flatten the data model to the transistor level. This shortens run time and provides a flexible, accurate, and convenient way for the circuit designer to evaluate inter-hierarchy coupling effects without propagating virtual nodes.

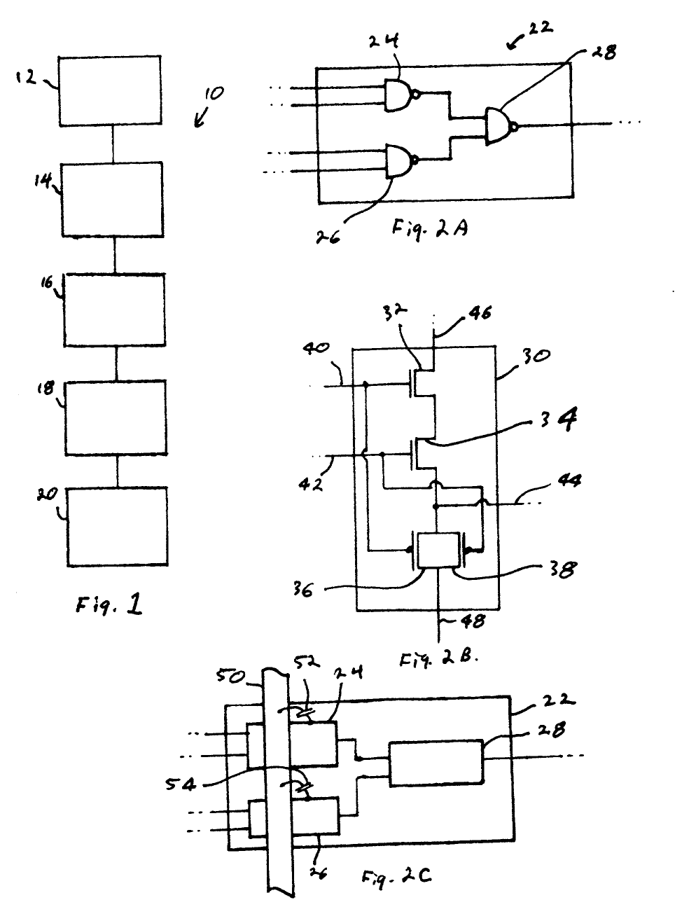

FIG. 1 is a simplified diagram of a hierarchy 10 that might be used in a CAD environment. The descriptions of the levels of hierarchy are exemplary only, and other levels might be defined in another CAD environment, or levels might be combined or omitted, depending on the type of CAD tool being used and the circuit being designed.

If an electronic circuit that is to be fabricated on a chip is the design goal, the top-level hierarchy 12 might relate to the flow plan of the chip. The second level hierarchy 14 might relate to the block level, where specific functional blocks are defined to achieve the flow plan of the higher level. Some blocks might be very specific in order to implement the higher-level hierarchy. The third level hierarchy 16 might relate to sub-blocks that combine various data paths and control blocks into commonly used elements of this level of hierarchy. Commonly used elements might be data processing routines, for example, that are used in several of the blocks of the higher-level hierarchy.

The fourth level hierarchy 18 might include control blocks, such as AND and NAND cells and unique cells designed by the circuit designer, including “megacells” that are designed with many transistors (compared to a NAND cell, for example) to achieve the functionality desired to implement the higher hierarchies. The lowest level hierarchy 20 might include the transistors, modeled with electronic components or with a data matrix, for example, and other discrete circuit elements, including parasitic elements and distributed elements. Terms such as “highest”, “lowest”, and “fifth” level are chosen merely as convenient terms of description, even though the “highest” level is the “first” level in this example. Other conventions could be chosen to describe a hierarchy.

Typically, some parasitic elements are included in standard device models, such as the input reactance of a device or cell. However, other parasitic effects can arise between levels of the hierarchy that are not easily handled with conventional intra-level techniques. Typically, the data relating to inter-level coupling is stored “flat”, i.e. without the benefits of a hierarchical system, or it is stored separately from the design. One problem that has arisen using a flattening technique is that the parasitic elements are modeled using nodes and connections that are not expressed in the structure of the physical circuit, often called “virtual” nodes. This can result in data extraction problems that modify the desired circuit design in some instances when the data extraction routine tries to create a physical node at the lower level to account for the virtual node. The circuit designer might then have to manually correct the lower level model.

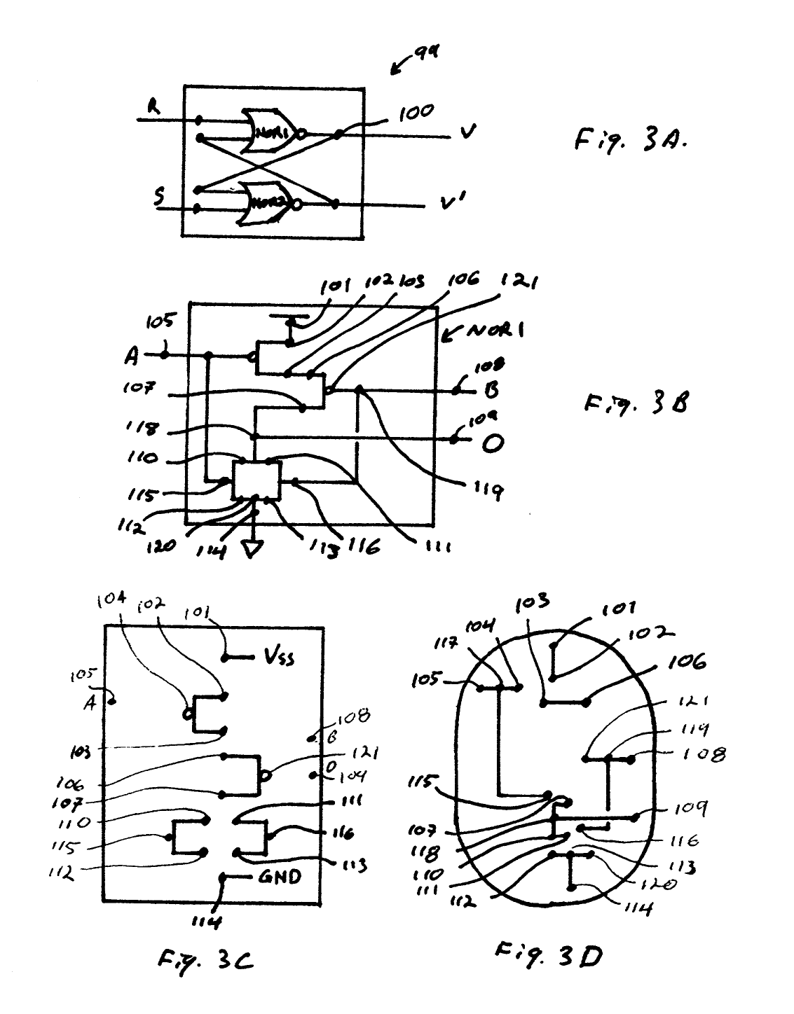

FIG. 2A is a simplified diagram of a 4-to-1 NAND block 22 that will be used to illustrate an embodiment of the present invention. The 4-to-1 NAND block has three 2-to-1 NAND gates 24, 26, 28. FIG. 2B is a simplified transistor-level circuit diagram of a 2-to-1 NAND cell 30 with two n-channel field effect transistors (“FETs”) 32, 34 and two p-channel FETs 36, 38. The two inputs 40, 42 are coupled through the FETs to the output 44 according to their logic states. A bias line 46 provides power to the cell, which is connected through the FETs to ground 48. Referring again to FIG. 2A, each of the three 2-to-1 NAND cells 24, 26, 28 is typically built from a standard NAND cell, which might generally correspond to the circuit shown in FIG. 2B. The hierarchy level below the cell level might then provide device-level modeling in which the FETS are modeled with circuit components such as resistors, capacitors, and voltage-controlled current sources.

In modern CAD systems, the device-level circuit model is often linked to a routine for generating a mask set that will be used to fabricate an integrated circuit on a semiconductor chip. For example, the n-channel FETs in the standard 2-to-1 NAND cell might be selected from a library of devices, each device in the library having an associated mask layout. As the circuit is “built” the same device or devices can be used to model a cell, which might be used over and over again in the circuit. Mega-cells that incorporate the function of several cells might also be used over and over again in the CAD circuit model. Evaluating the circuit at a cell level, rather than at the device or component level, allows the modeling software to emulate circuit performance with fewer modeling elements. This in turn enhances the speed with which the CAD software runs and allows the design engineer to evaluate changes in the circuit or layout more quickly and more easily.

FIG. 2C illustrates a problem that arises in modeling in a hierarchical environment. The 4-to-1 NAND block 22 of FIG. 2A is shown with each 2-to-1 NAND cell as a functional cell block. For the purposes of discussion, each 2-to-1 NAND cell 24, 26, 28 uses the same transistor-level circuit model. However, a conductive trace 50, such as a bus line, overlies two of the 2-to-1 NAND cells 24, 26, but not the third 2-to-1 NAND cell 28. In the physical circuit the cell would be laid out as shown in FIG. 2B, and the conductive trace would be in a metallization layer above the cells. This conductive trace capacitively couples to two of the underlying NAND cells 24, 26, but essentially not to the third NAND cell 28. This capacitive coupling is represented as capacitors 52, 54 between the conductive trace and the NAND cells, and might manifest on a node of the underlying gate, i.e. the capacitor couples between the bus and a particular lower trace.

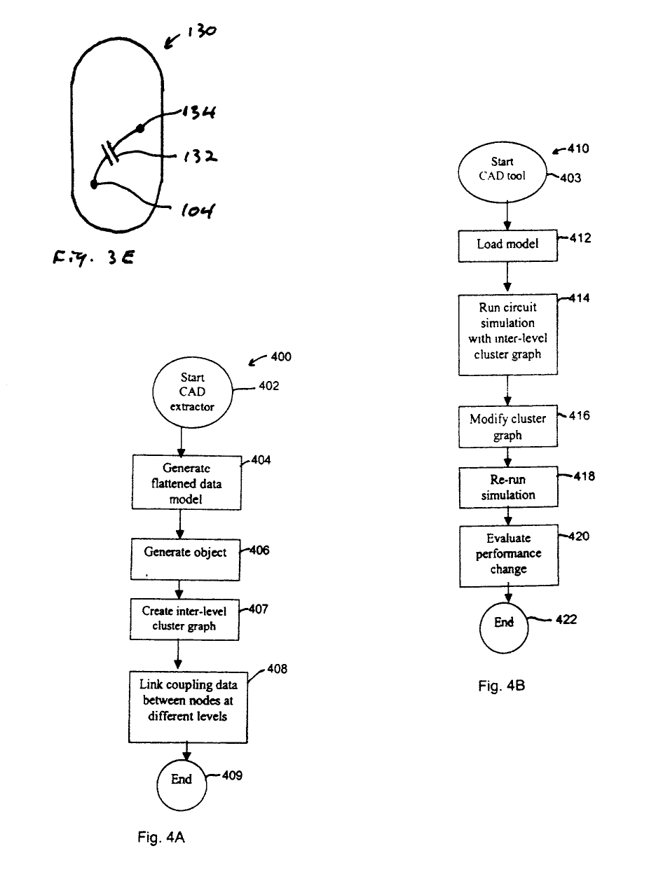

FIG. 3A is a simplified diagram of an RS latch 99 at a top level that will be used to illustrate an embodiment of the present invention. The RS latch has two inputs R, S and provides an output V (arbitrarily designated) and an inverse output V′, commonly called “V-bar”. The RS latch includes two NOR gates, NOR1 and NOR2. For purposes of discussion, the output node 100 of NOR1 capacitively couples to another node of NOR1.

FIG. 3B is a simplified circuit diagram of NOR1 having two inputs A, B, an output O, and several nodes 101, 102, 103, 104, 105, 106, 107, 108, 109, 110, 111, 112, 113, 114, 115, 116, 117, 118, 119, 120, and 121. These nodes are designated in order to understand the following view and cluster base representation of NOR1 at the gate level.

FIG. 3C is a view of NOR1 in a CAD representation. The view has arranged various elements of the gate, such as FETs, bias voltage Vss, and ground GND, according to the nodes identified in FIG. 3B. FIG. 3D is a base cluster for NOR1, and provides the connectivity information for the view of FIG. 3C. Thus the CAD tool combines the view of FIG. 3C with the base cluster of FIG. 3D to arrive at NOR1, as shown in FIG. 3B. If NOR2 is the same as NOR1, it would have the same view and base cluster, and the CAD tool would call them from the library for both gates.

However, suppose the output node 100 of NOR1 capacitively couples to node 104 (see FIG. 3B) of NOR1. A conventional approach is to flatten the hierarchy to the transistor level, but this is undesirable for large circuits. Another approach is to promote node 104 of NOR1 to the top level. However, if the CAD tool then goes into NOR1 and attempts to perform a delay calculation based on an RC product, the inter-level capacitance is missing, resulting in inaccurate modeling. It is undesirable to place a capacitor representing the inter-level coupling into the NOR model, because NOR2 doesn't have this capacitance.

FIG. 3E is a simplified representation of another cluster 130 associated with NOR1, which will be called an inter-level cluster for purposes of discussion. This cluster stores the coupling information between the output of NOR1 100 and node 104 of NOR1. This cluster might be named cluster_nor1, for example, and has a capacitor 132 between node 104 and an artificial node 134. The artificial node might be named Top::100, for example, to indicate that it is an artificial node at a lower level of hierarchy representing coupling to the top level node 100 (see FIG. 3A). Now, when the CAD tool goes into NOR1 it overlaps the base cluster of FIG. 3D with the inter-level cluster of FIG. 3E and can account for the cross-level coupling. When the CAD tool goes into NOR2, only the cluster base (FIG. 3D) is used with the NOR view (FIG. 3C), assuming NOR2 doesn't also have inter-level coupling data in another associated cluster, such as a cluster_nor2. Hence it is possible to push down cross-hierarchy information into the lower hierarchy without the overhead of complete flattening.

The second cluster may be more complex than a single capacitor. For example, it might be a resistor-capacitor (“RC”) tree, or a resistor that represents leakage current between levels. Similarly, two levels might inductively couple, thus the second cluster might include an inductor. Using a second cluster that is overlapped with the base cluster provides a flexible technique for efficiently modeling a circuit. Although the above example uses a second cluster overlapped with the base cluster at the gate level linked through an artificial node to the top level, clusters having inter-level coupling data can be used at different levels or between different levels of the hierarchy.

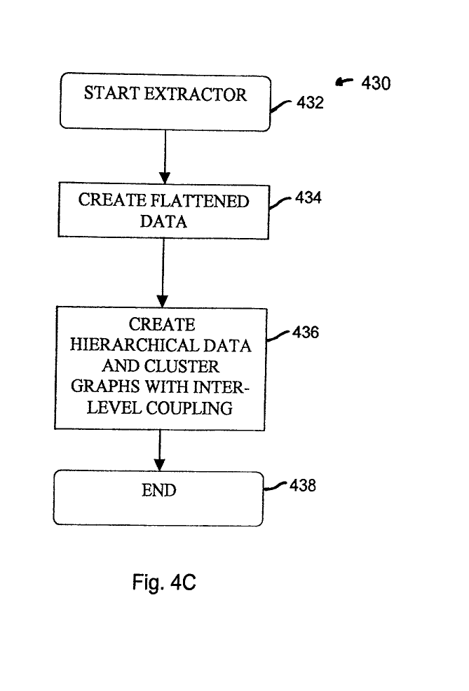

FIG. 4A is a simplified flow diagram of a method 400 for creating a cluster graph according to an embodiment of the present invention. A CAD extractor using a hierarchical technique is started (step 402). The CAD extractor is an application that extracts data from silicon equivalent layout data and represents the data as resistance, capacitance, and inductance connections, for example. The extractor generates a flattened circuit representation (data model) (step 404) that uses the flattened circuit representation to generate an object represented by a view and a base cluster (step 406). The user creates an inter-level cluster having inter-level coupling data (step 407) and links the inter-level cluster between a node of the object and an artificial node at a higher level of the hierarchy (step 408), and the process ends (steps 409). The cluster graph with the inter-level coupling data can now be used to simulate circuit performance. The cluster graph data can be generated by the extractor, or from other simulations or measurements.

FIG. 4B is a simplified flow diagram of a method 410 for modeling an integrated circuit according to an embodiment of the present invention using a CAD tool operating on a computer system. A CAD tool configured to model an integrated circuit using a hierarchical technique is started or initialized (step 403). A hierarchical circuit model is loaded into the CAD tool (step 412). The hierarchical circuit model includes at least one inter-level cluster. A non-flattened circuit model is run to simulate performance of the physical circuit (step 414) in which the inter-level cluster is overlapped with a base cluster. In other embodiments, circuit model includes several inter-level cluster graphs. In a further embodiment, some of the inter-level cluster graphs are the same.

In further embodiment, the inter-level cluster graph is modified (step 416) to simulate a change in the circuit layout that is expected to affect inter-level coupling. The change could be moving a conductive trace with respect to the underlying circuit elements, for example. The circuit model is then re-run (step 418) to evaluate the effect of the proposed change in layout on circuit performance (step 420). When the simulation is complete, the process ends (step 422).

FIG. 4C is a simplified flow chart of a method 430 of generating a cluster graph according to another embodiment of the present invention. An extractor of the CAD tool is started (step 432) that runs on a data model of an integrated electronic circuit. The extractor creates flattened data of the integrated electronic circuit (step 434), and then creates the hierarchical circuit model including cluster graphs representing inter-level coupling (step 436). In this instance, the extractor has been developed to extract inter-level coupling data as well as the hierarchical data from the flattened data. The method then ends (step 438). The hierarchical data and cluster graphs with inter-level coupling data can then be used to simulate performance of the integrated electronic circuit.

While the invention has been described in conjunction with several specific embodiments, it is evident to those skilled in the art that many further alternatives, modifications, and variations will be apparent in light of the foregoing description. For example, a cell-level hierarchy of an integrated circuit chip has been used to illustrate the invention, but clusters could be used to account for inter-hierarchy coupling between other levels. Similarly, clusters could be used to account for inter-hierarch coupling between hierarchical levels of a hybrid integrated circuit, i.e. a circuit with interconnected chips. Thus, the invention described herein is intended to embrace all such alternatives, modifications, applications, and variations as may fall within the spirit and scope of the following claims.

What is claimed is:

1. A cluster graph stored in a computer-readable medium for use in a simulation of an integrated circuit on a computer-aided-design (“CAD”) tool, the cluster graph comprising:
data;
a first node designation; and
a second node designation, the first node designation representing a first node at a first level of hierarchy and the second node designation representing a second node at a second level of hierarchy, the second node designation being an artificial node at the first level of hierarchy, the second level of hierarchy being higher than the first level of hierarchy, and the data representing inter-level coupling between the first node and the second node.

2. The cluster graph of claim I wherein the data representing inter-level coupling of the integrated circuit comprises a resistor-capacitor tree.

3. The cluster graph of claim 1 wherein the first level of hierarchy is a gate level and the second level of hierarchy is a top level.

4. A cluster graph stored in a computer-readable medium for use in a simulation of an integrated circuit on a computer-aided-design (“CAD”) tool, the cluster graph comprising:
data;
a first node designation; and
a second node designation, the first node designation representing a first node at a gate level of hierarchy and the second node designation representing a second node at a top level of hierarchy, the second node designation being an artificial node at the gate level of hierarchy, and the data representing a resistor-capacitor tree between the first node and the second node.

5. An integrated electronic circuit model stored on a computer-readable medium, the integrated electronic circuit model comprising:
a view of an object having a first node at a first level of hierarchy;
a base cluster of the object at the first level of hierarchy; and
an inter-level cluster of the object between the first node at the first level of hierarchy and an artificial node at the first level of hierarchy, the artificial node corresponding to a second node at a second level of hierarchy, the second level of hierarchy being higher than the first level of hierarchy, wherein the electronic circuit model overlaps the base cluster with the inter-level cluster.

6. The integrated electronic circuit model of claim 5 wherein the inter-level cluster is a resistor-capacitor tree.

7. The integrated electronic circuit model of claim 5 wherein the first level of hierarchy is above a transistor-level of hierarchy.

8. The integrated electronic circuit model of claim 5 wherein the base cluster is extracted from flattened data of the integrated electronic circuit model.

9. The integrated electronic circuit model of claim 5 further comprising
a second instance of the object at the first level of hierarchy, the second instance of the object being represented by the view and the base cluster; and
a second inter-level cluster at the first level of hierarchy having inter-level coupling data between a third node of the second instance of the object and a fourth node, the forth node being on a third level of hierarchy.

10. The integrated electronic circuit model of claim 9 wherein the third level of hierarchy is the second level of hierarchy.

11. The integrated electronic circuit model of claim 9 wherein the data in the second inter-level cluster is the data in the inter-level cluster.

12. The integrated circuit model of claim 9 wherein the first level of hierarchy is a gate level of hierarchy.

13. An integrated electronic circuit model stored on a computer-readable medium, the integrated electronic circuit model comprising:
a first instance of an object at a gate level of hierarchy of the integrated electronic circuit model, the object being represented by a view and a base cluster;
a second instance of the object at the gate level of hierarchy;
a first inter-level cluster of the first instance of the object between a first node of the first instance and a first artificial node, the first artificial node corresponding to a first higher-level node at a second level of hierarchy, the second level of hierarchy being higher than the first level of hierarchy; and
a second inter-level cluster of the second instance of the object between a second node of the second instance and a second artificial node, the second artificial node corresponding to a second higher-level node at the second level of hierarchy, wherein the electronic circuit model overlaps the base cluster with the first inter-level cluster to model the first instance of the object and overlaps the base cluster with the second inter-level cluster to model the second instance of the object.

14. A method of creating an inter-level cluster graph for simulating inter-level coupling in an hierarchical integrated electronic circuit model on a computer-aided-design (“CAD”) tool, the method comprising:
starting an extractor application of the CAD tool;
generating a flattened data model generating an object at a first level of hierarchy from the flattened data model, the object being represented by a view and a base cluster graph;
entering inter-level coupling data between a node of the object and a second node at a second level of hierarchy into the inter-level cluster graph; and
linking the first node to the second node in the inter-level cluster graph.

15. The method of claim 14 A-herein in the first level of hierarchy is higher than a transistor level.

16. The method of claim 14 wherein the inter-level cluster graph is a resistor-capacitor tree.

17. A method of modeling an integrated circuit on a computer system, the method comprising:
starting a CAD tool on the computer system;
loading a hierarchical circuit model into the CAD tool;
running a non-flattened simulation of the integrated circuit at a first level of hierarchy with the CAD tool on the computer system, the simulation including an object with a node, by overlapping an inter-level cluster graph containing coupling data between the node and a second node, the second node being at a second level, with a base cluster graph of the object.

19. The method of claim 17 wherein the simulation further includes a second instance of the object and a second inter-level cluster graph containing coupling data between a third node of the second instance of the object and a fourth node.

20. The method of claim 17, further comprising, after the running a non-flattened simulation step, steps of
modifying the inter-level cluster graph to contain second coupling data;
re-running the simulation with the second coupling data; and
comparing a result from running the simulation with a second result from re-running the simulation.
